(19) United States
(12) Patent Application Publication
(10) Pub. No.: US 2010/0215135 A1
(43) Pub. Date: Aug. 26, 2010

(54) SYNCHRONOUS PROCESSING APPARATUS, RECEIVING APPARATUS AND SYNCHRONOUS PROCESSING METHOD

(75) Inventor: Mitsuji OKADA, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/708,715

(22) Filed: Feb. 19, 2010

(30) Foreign Application Priority Data
Feb. 24, 2009 (JP) 2009-040439

(51) Int. Cl. H04L 7/04

(52) U.S. Cl. 375/362

(57) ABSTRACT

A receiving apparatus 100 in accordance with an exemplary aspect of the present invention is including a receiving unit 1 that receives an analog signal, a sample signal generation unit 2 that converts an analog signal received by the receiving unit 1 into a digital signal, and generates a sample signal by performing oversampling, a correlation unit 51 that obtains correlation between the sample signal and a known signal pattern, a symbol section estimation unit 53 that estimates timing of a symbol section based on the correlation value, and a sampling position determination unit 54 that determines a sampling position based on timing of a symbol section estimated by the symbol section estimation unit 53.

### INCORPORATION BY REFERENCE

This application is based upon and claims the benefit of priority from Japanese patent application No. 2009-040439, filed on Feb. 24, 2009, the disclosure of which is incorporated herein in its entirety by reference.

### BACKGROUND

1. Field of the Invention

The present invention relates to a synchronous processing apparatus, a receiving apparatus and a synchronous processing method, in particular to high-precision symbol section estimation.

2. Description of Related Art

In the field of digital communications, communications are implemented by using packets each composed of a header and a payload that contains the data to be transmitted/received. In such a case, it is necessary to carry out synchronous processing to detect the boundary between the header and the payload of the packet data on which digital signal processing was performed, and to thereby demodulate proper data from the digital signal. Since the accuracy of this synchronous processing significantly affects the accuracy of the receiving quality, the realization of high-precision synchronous processing has been desired.

Japanese Unexamined Patent Application Publication No. 2001-103044 discloses a technique in which a correlation value between a known synchronous pattern and a received signal is acquired, and a sample point around the highest correlation value is used as symbol timing.

### SUMMARY

A symbol timing detection method disclosed in Japanese Unexamined Patent Application Publication No. 2001-103044 is explained hereinafter. A correlation series with a known synchronous pattern is calculated for each of sampling data that are obtained by performing oversampling for multiple times for each symbol. FIG. 15 shows correlation values obtained for each sampling data. Then, a threshold for correlation values indicating a constant value is prepared, and among sample points that are located on the front side of the sample point indicating the highest correlation value, a sample point for which the correlation value is larger than or equal to the threshold and which is located at the forefront is detected as symbol timing.

However, in the method using only sampling points with a provided threshold, it is very difficult to extract a symbol sampling point of a received signal that constantly varies due to interference. This is because the timing at which the correlation value becomes the highest depends on the received signal and thus is impossible to estimate, and at the same time, the deviation of the timing becomes larger due to the provision of an absolute threshold.

A first exemplary aspect of the present invention is a synchronous processing apparatus including: a correlation unit that obtains correlation between a sample signal and a known signal pattern and acquires a correlation value in succession, the sample signal being generated by oversampling a received analog signal; a symbol section estimation unit that estimates timing of a symbol section based on the correlation value; and a sampling position determination unit that determines a sampling position based on timing of a symbol section estimated by the symbol section estimation unit.

Further, a second exemplary aspect of the present invention is a receiving apparatus including: a receiving unit that receives an analog signal; a sample signal generation unit that converts an analog signal received by the receiving unit into a digital signal, and generates a sample signal by performing oversampling; a correlation unit that obtains correlation between the sample signal and a known signal pattern and acquires a correlation value in succession; a symbol section estimation unit that estimates timing of a symbol section based on the correlation value; and a sampling position determination unit that determines a sampling position based on timing of a symbol section estimated by the symbol section estimation unit.

Further, a third exemplary aspect of the present invention is a synchronous processing method including: obtaining correlation between a sample signal and a known signal pattern and acquiring a correlation value in succession, the sample signal being generated by oversampling a received analog signal; estimating timing of a symbol section based on the correlation value; and determining a sampling position based on timing of the estimated symbol section.

In accordance with an exemplary aspect of the present invention, a correlation value between sampling data, on which oversampling was performed, and a known signal pattern is calculated to detect each symbol section. That is, since a proper symbol section can be calculated even when the received signal is changed due to interference, it is possible to detect symbol timing with high accuracy.

The present invention can provide, in an exemplary aspect, a receiving apparatus that performs high-precision symbol section estimation and a symbol section estimation method.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a receiving apparatus in accordance with a first exemplary aspect of the present invention;

FIG. 2 is a configuration diagram of a synchronous circuit in accordance with a first exemplary aspect of the present invention;

FIG. 3 shows a frame structure of data in accordance with a first exemplary aspect of the present invention;

FIG. 4 shows an oversampling operation of digital data in accordance with a first exemplary aspect of the present invention;

FIG. 5 shows operations to generate a correlation value of a synchronous signal in accordance with a first exemplary aspect of the present invention;

FIG. 6 shows relation between correlation values of a synchronous signal and sample data in accordance with a first exemplary aspect of the present invention;

FIG. 7 is a process flowchart of a receiving apparatus in accordance with a first exemplary aspect of the present invention;

FIG. 8 shows a waveform of a received signal of sample data in accordance with a first exemplary aspect of the present invention;

FIG. 9 shows a waveform of a received signal of sample data in accordance with a first exemplary aspect of the present invention;

FIG. 10 is a configuration diagram of a synchronous circuit in accordance with a second exemplary aspect of the present invention;

FIG. 11 shows operations to generate a correlation value of a synchronous signal in accordance with a second exemplary aspect of the present invention;

FIG. 12 shows relation between correlation values of a synchronous signal and sample data in accordance with a second exemplary aspect of the present invention;

FIG. 13 shows operations to generate a correlation value of a synchronous signal in accordance with a second exemplary aspect of the present invention;

FIG. 14 shows relation between correlation values of a synchronous signal and sample data in accordance with a second exemplary aspect of the present invention; and

FIG. 15 shows relation between correlation values of a synchronous signal and sample data in accordance with a receiving apparatus in related art.

### DETAILED DESCRIPTION OF THE EXEMPLARY EMBODIMENTS

### First Exemplary Embodiment

Exemplary embodiments of the present invention are explained hereinafter with reference to drawings.

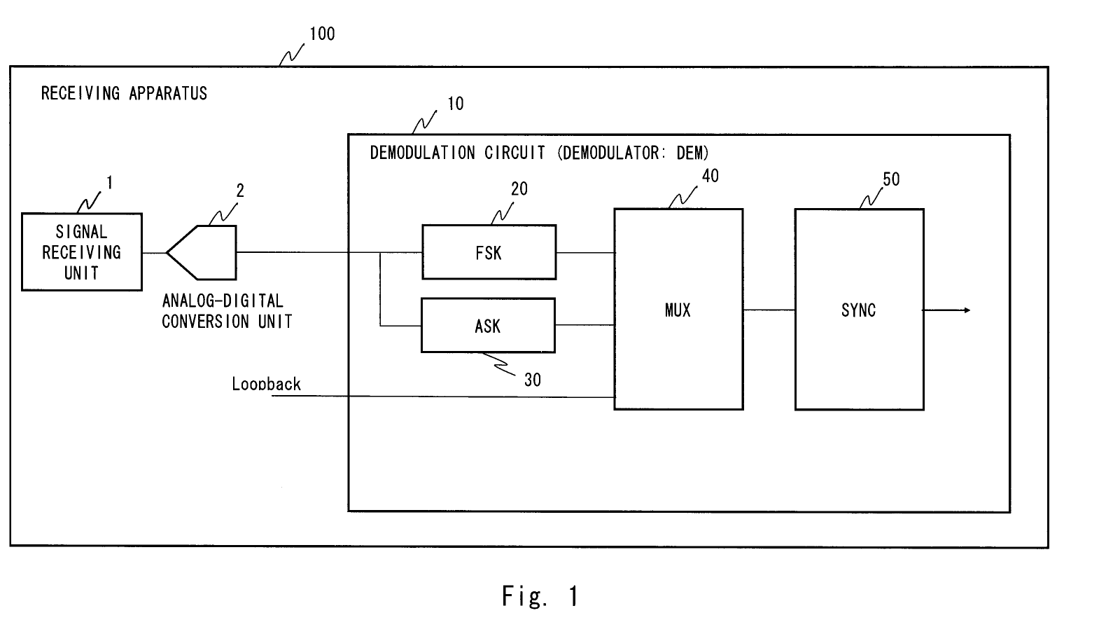

A configuration of a receiving apparatus in accordance a first exemplary embodiment of the present invention is explained with reference to FIG. 1. A receiving apparatus 100 includes a signal receiving unit 1, an analog-digital conversion unit 2, and a demodulation circuit (Demodulator: DEM) 10. Further, the demodulation circuit 10 includes a frequency shift keying unit (Frequency Shift Keying: FSK) 20, an amplitude shift keying unit (Amplitude Shift Keying: ASK) 30, a selection unit (MUX) 40, and a synchronous circuit (SYNC) 50. The signal receiving unit 1 outputs an acquired analog signal to the analog-digital conversion unit 2. The analog-digital conversion unit 2 converts the acquired analog signal into a digital signal, and performs oversampling to generate a plurality of sample data. The generated sample data are output to the FSK 20 or the ASK 30. The FSK 20 performs frequency shift modulation (or keying) processing on the acquired digital signal, and outputs the processed signal to the MUX 40. The ASK 30 performs amplitude shift modulation (or keying) processing on the acquired digital signal, and outputs the processed signal to the MUX 40. The MUX 40 selects a signal from among signals from the FSK 20 and ASK 30, and the Loopback, which is a signal returned from the transmitter to the receiving side for verifying functions of the digital circuit, and outputs the selected signal to the SYNC 50.

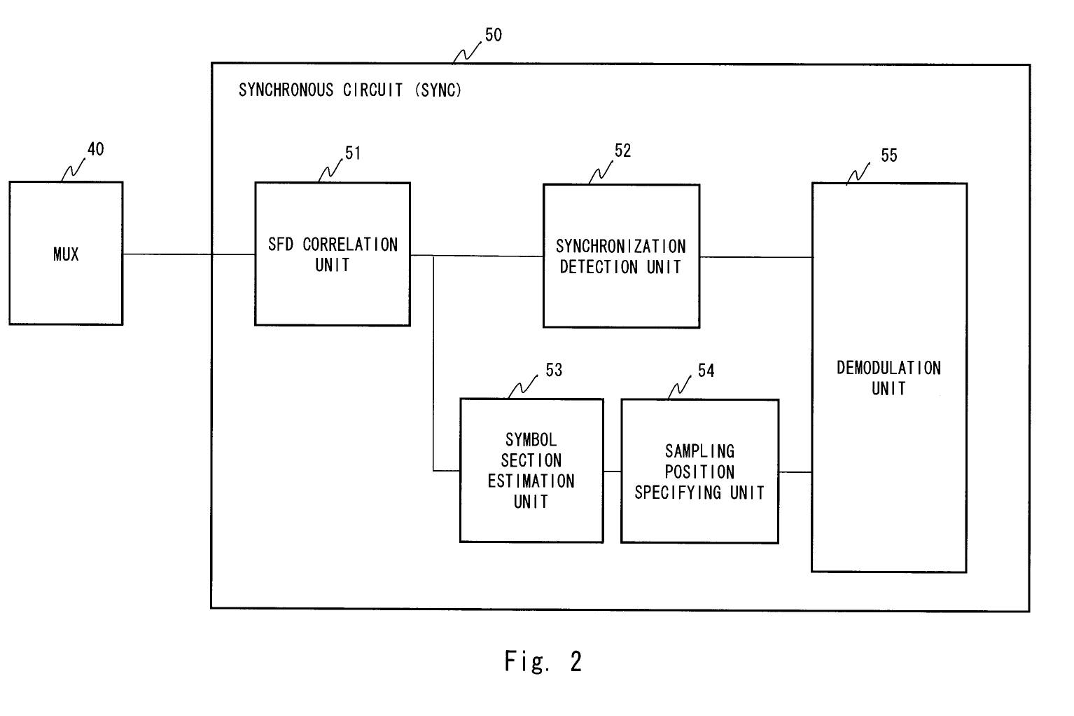

Next, a configuration of a synchronous circuit 50 in accordance with a first exemplary embodiment of the present invention is explained with reference to FIG. 2. The synchronous circuit 50 includes an SFD correlation unit 51, a synchronization detection unit 52, a symbol section estimation unit 53, a sampling position specifying unit 54, and a demodulation unit 55. A correlation value calculated by the SFD correlation unit 51 is output to the symbol section estimation unit 53 and the synchronization detection unit 52. The synchronization detection unit 52 detects the boundary between a synchronous signal and a payload from the acquired correlation value, and outputs the detected boundary to the demodulation unit 55. The symbol section estimation unit 53 estimates a symbol section and its center timing from the acquired correlation value, and outputs them to the sampling position specifying unit 54. The sampling position specifying unit 54 specifies a sampling position from the acquired center timing of the symbol section, and outputs the specified sampling position to the demodulation unit 55.

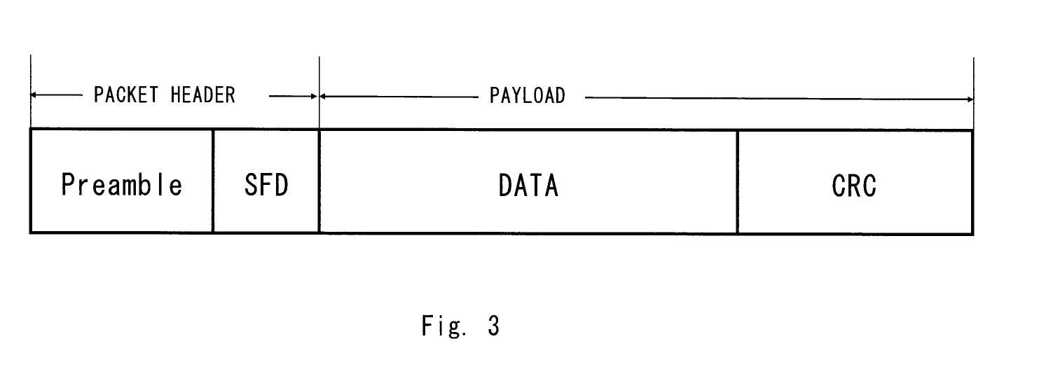

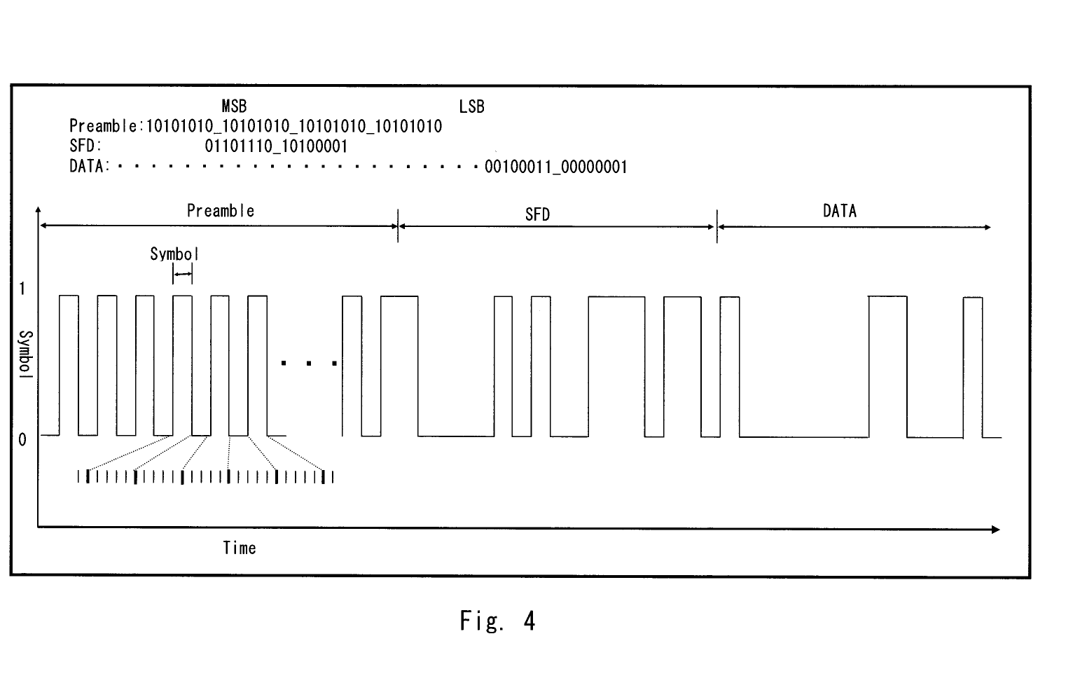

The SFD correlation unit 51 acquires correlation value between data demodulated by the FSK 20 or the ASK 30 and the synchronous signal. The frame structure of data that is to be received by the SFD correlation unit is explained hereinafter with reference to FIG. 3. Further, an oversampling operation is explained with reference to FIG. 4.

FIG. 3 shows a frame structure of data to be received by the SFD correlation unit 51. The frame is composed of a Packet Header and a Payload. The packet header includes a Preamble and an SFD (Start Frame Delimiter; synchronous signal). The preamble is a signal located at the front end of the frame, and is used for the sweep processing of a received signal. The synchronous signal is a signal used to recognize that the packet is sent to that particular receiving apparatus. The payload includes DATA and a CRC (Cyclic Redundancy Check). In the DATA, data that is actually transmitted/received is placed. The CRC is an error detection code used to detect an error in the frame.

FIG. 4 shows an overview of oversampling operation. The horizontal axis represents time, and the vertical axis represents oversampled values, i.e., “1” or “0”. FIG. 4 shows a situation where one symbol used for a preamble is oversampled for five times. Therefore, each symbol is composed of five sample data.

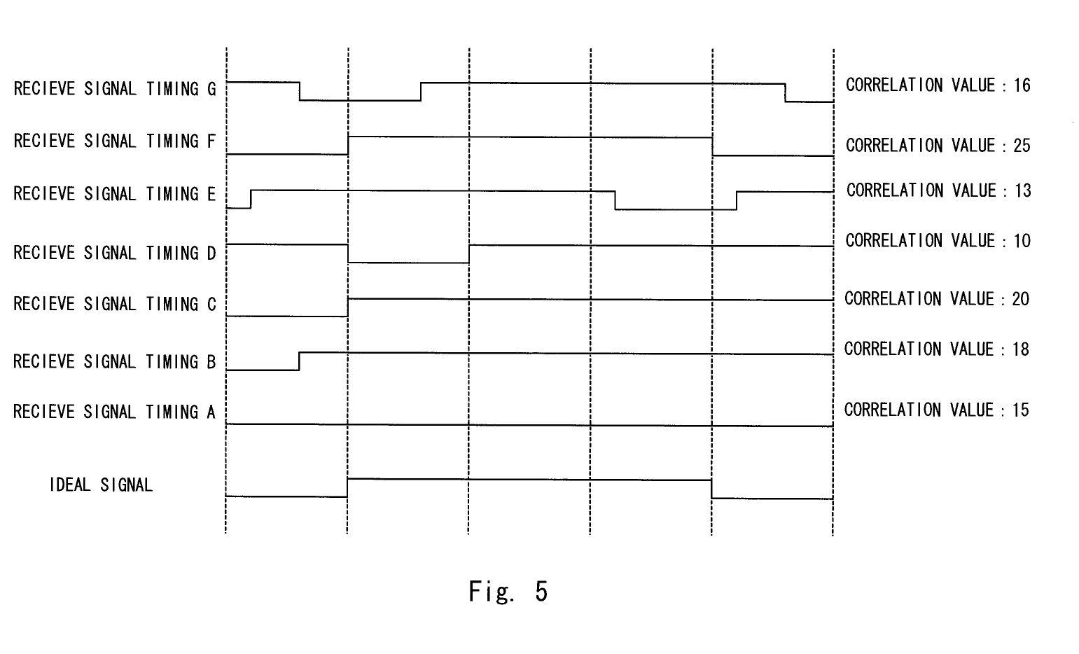

Next, an acquiring method of a correlation value in the SFD correlation unit 51 is explained with reference to FIG. 5. The “ideal signal” represents a known synchronous signal pattern possessed by the receiving apparatus 100. In this example, a synchronous signal pattern for five symbols is shown. A value “0” is set to the first symbol; a value “1” is set to each of the second to fourth symbols; and a value “0” is set to the fifth symbol. Each of the “receive signals” is a received signal obtained by oversampling, and each of the “timing A” to “timing G” is arbitrary timing. With the “timing F”, the received signal completely matches with the “ideal signal”, and its correlation value indicates 25. In this way, a correlation value is acquired for each of all timings.

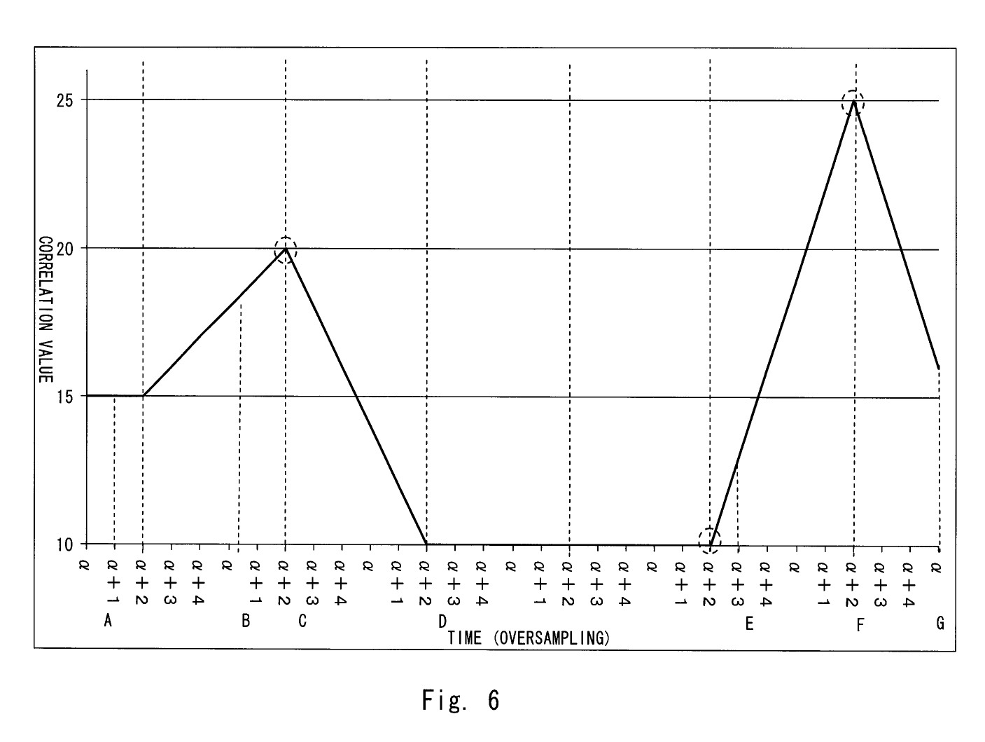

The symbol section estimation unit 53 shown in FIG. 2 estimates a symbol section from a correlation value acquired from the SFD correlation unit 51. A specific estimating method of a symbol section is explained with reference to FIG. 6.

FIG. 6 shows correlation values at respective sampling times shown in the example of FIG. 5. The vertical axis represents correlation values between received signals and a known synchronous signal pattern (ideal signal). The horizontal axis represents time at which oversampling is performed. In the graph shown in FIG. 6, the timing C, timing preceding the timing E by one sampling, and the timing F indicate a maximum value or a minimum value in the correlation values, and therefore they can be presumed to be timing indicating a symbol end.

The sampling position specifying unit 54 shown in FIG. 2 specifies the center of the symbol section estimated by the symbol section estimation unit 53 as a sampling position at which sampling is performed to demodulate data in the payload. As seen from the graph of FIG. 6, the estimated symbol end indicates the timing at α+2, and the timing of the symbol center is thereby presumed to be the timing at a from this estimation.

The synchronization detection unit 52 shown in FIG. 2 detects a synchronous signal by using the timing F with which the correlation value becomes the highest, and thereby can detect the boundary between the synchronous signal (SFD) and the payload shown in FIG. 3.

The demodulation unit 55 shown in FIG. 2 defines the α timing, which is the center of the symbol section specified by the sampling position specifying unit 54, as symbol sampling timing in the payload specified by the synchronization detection unit 52, and performs demodulation.

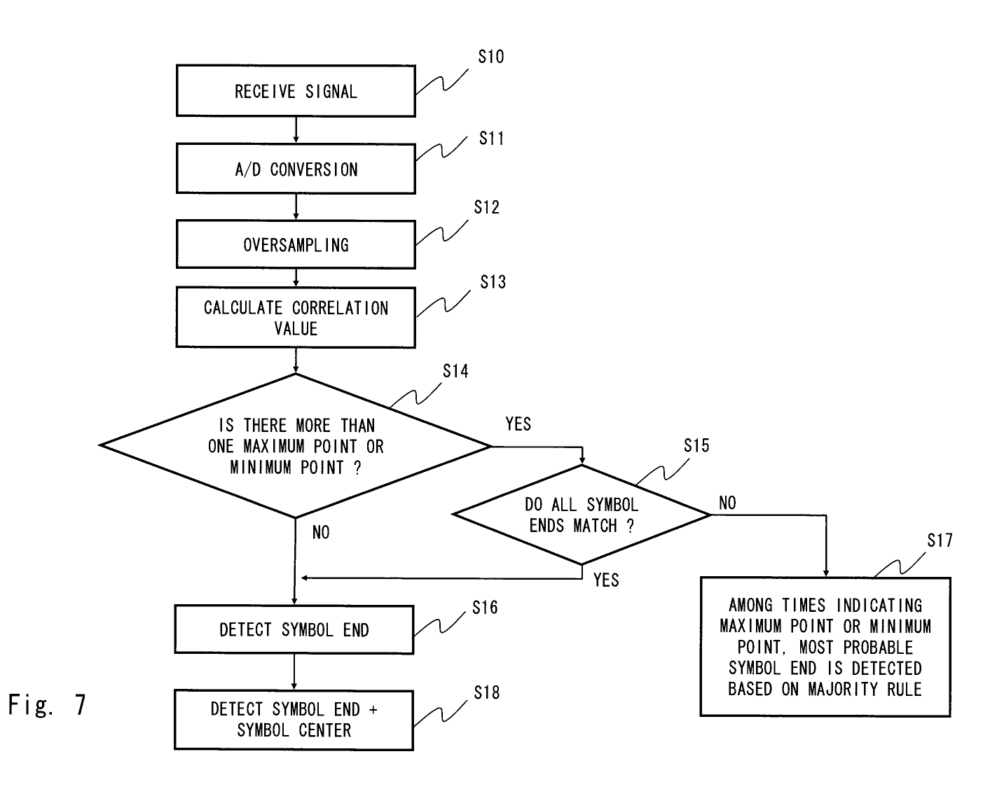

Next, a flow of processing of a receiving apparatus in accordance with a first exemplary embodiment of the present invention is explained with reference to FIG. 7. The signal receiving unit 1 receives analog data (S10). Next, the analog-digital conversion unit 2 converts the received analog data into a digital signal (S11).

Next, the analog-digital conversion unit 2 performs oversampling on the digital signal to acquire sampling data (S12). Specifically, in a case where oversampling is performed for five times on each symbol, if oversampling is repeated for five symbols, 25 sample data are output.

Next, the SFD correlation unit 51 calculates a correlation value between digital signals for the 25 samples acquired from the analog-digital conversion unit 2 and a known synchronous signal pattern possessed by the receiving apparatus 100 (S13). Specifically, each symbol is composed of five sample data, and sample data for which each sample matches with a value set in a known synchronous signal pattern is detected. The number of matched sample data is calculated as a correlation value.

Next, the symbol section estimation unit 53 estimates a symbol section from the correlation value calculated by the SFD correlation unit 51. Specifically, as shown in FIG. 6, the relation between the time at which oversampling is performed and the correlation value is used. In this process, it is determined whether or not there is more than one maximum point or minimum point in the correlation value (S14). As a result, if there is only one maximum point or only one minimum point, a symbol end is estimated from the sampling timing indicating the maximum point or the minimum point (S16).

Further, if there is more than one maximum point or minimum point in the correlation value and the sampling timings of all the maximum points and minimum points are the same (S15), that same sampling timing is adopted as an estimated value (S16). If the symbol ends are different for each of the times indicating the maximum points and minimum points (S15), the most probable symbol end can be adopted among the times indicating the maximum points and minimum points based on majority rule or the like (S17). Note that if every symbol end is different for each of the times at which oversampling is performed and which indicate the maximum points and minimum points, the decision on which one of the symbol ends corresponding to the times of the maximum points and minimum points should be adopted can be arbitrarily made.

Next, the symbol section estimation unit 53 specifies a symbol section from the estimated symbol end, and thereby estimates the center timing of the symbol section (S18). Specifically, for estimating the center timing of a symbol section, a number is calculated by dividing the number of times of the oversampling by two and rounding up the divided value to the nearest integer. Then, a block corresponding to the calculated number can be defined as the center timing of the symbol section. For example, when the number of times of oversampling is five, from the calculation 5/2=2.5, the third (i.e., a number obtained by rounding up to the nearest integer) timing can be defined as the center timing of the symbol section.

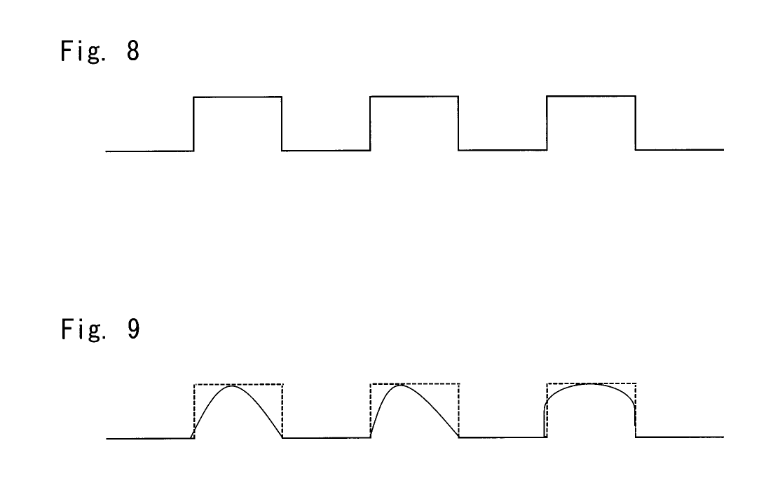

The center timing of a symbol section is calculated as explained above, and some of the merits obtained by demodulating data by using the center timing are described hereinafter. As shown in FIG. 8, the waveform of data to be received ideally has such a shape that the boundary of symbols is expressed by a rectangular shape. However, due to the influence of interference and the like, the signal may become blunted. In such a case, if the demodulation can be always performed at the center timing, the data can be correctly demodulated.

### Second Exemplary Embodiment

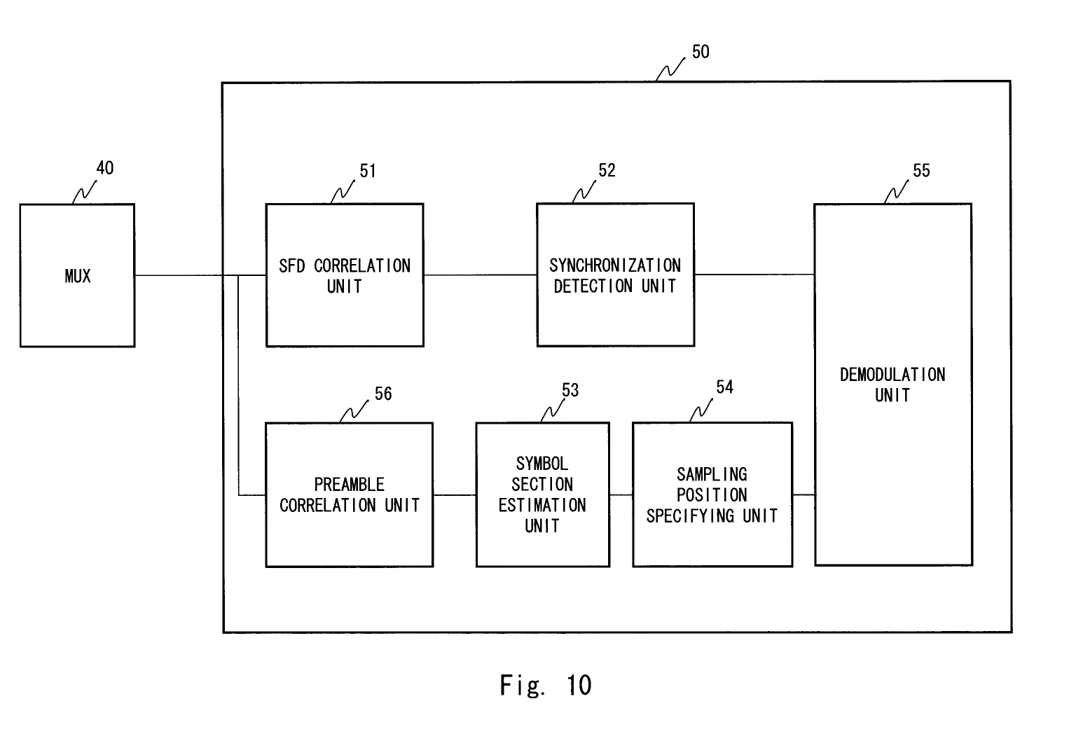

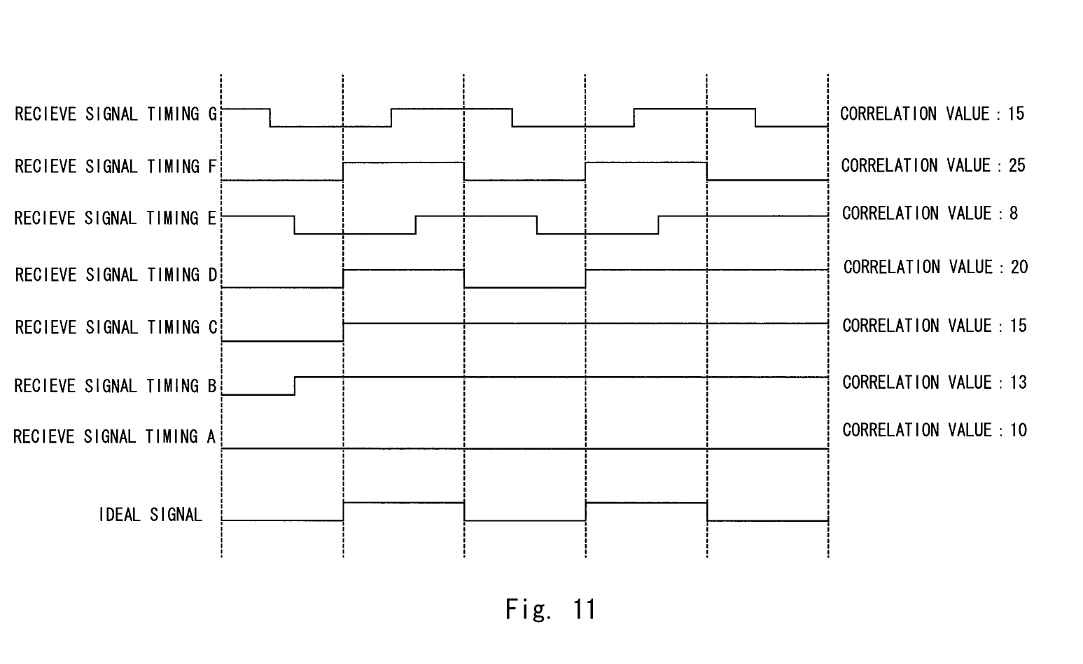

Next, a configuration of a synchronous circuit 50 in accordance with a second exemplary embodiment of the present invention is explained with reference to FIG. 10. The synchronous circuit 50 includes an SFD correlation unit 51, a synchronization detection unit 52, a symbol section estimation unit 53, a sampling position specifying unit 54, a demodulation unit 55, and a preamble correlation unit 56. The SFD correlation unit 51 calculates a correlation value by using each sample data and a synchronous signal pattern, and outputs the calculated correlation value to the synchronization detection unit 52. The synchronization detection unit 52 detects the boundary between the synchronous signal and the payload by detecting the highest correlation value of each data, and outputs the detected boundary to the demodulation unit 55.

The preamble correlation unit 56 acquires correlation between data demodulated by the FSK 20 or the ASK 30 and a preamble signal. The preamble signal is a signal which is expressed by a digital signal as “10101010”, for example, and for which bit values set to adjacent symbols are different.

Next, an acquiring method of a correlation value in the preamble correlation unit 56 is explained hereinafter with reference to FIG. 11. Since the “ideal signal” is expressed as “10101010”, for example, by a digital signal, a waveform is formed such that adjacent symbols indicate different bit values. In FIG. 11, a value “0” is set to each of the first, third and fifth symbols, and a value “1” is set to each of the second and fourth symbols. The calculation method of a correlation value is similar to the acquiring method of a correlation value in the SFD correlation unit 51 shown in FIG. 5.

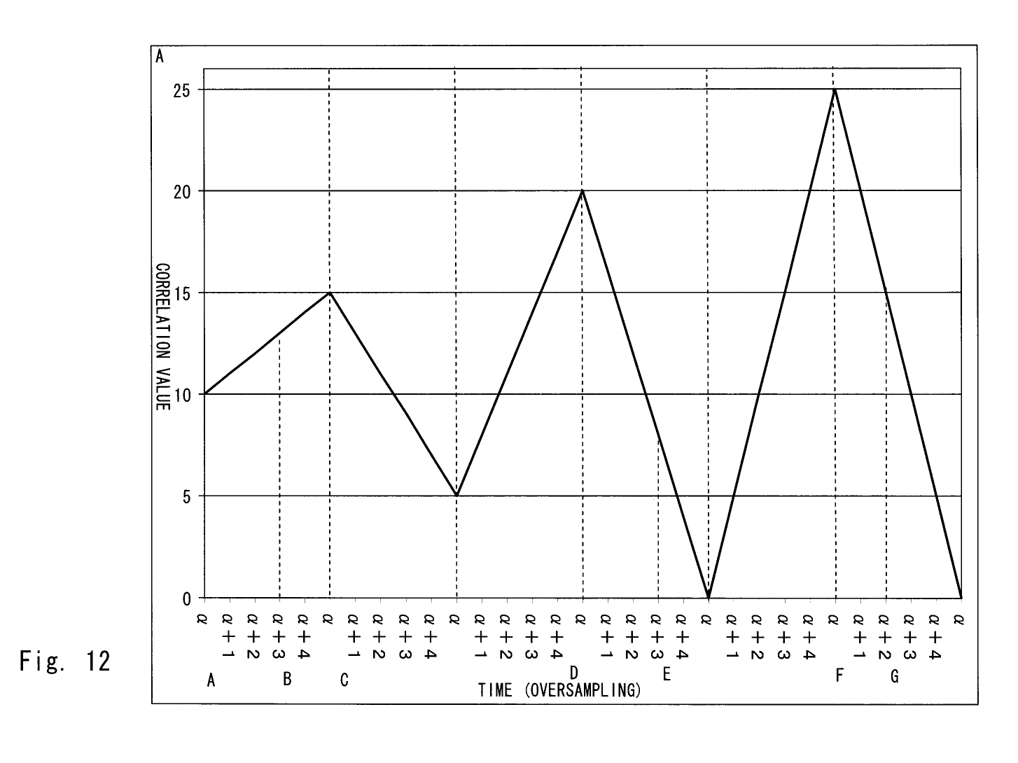

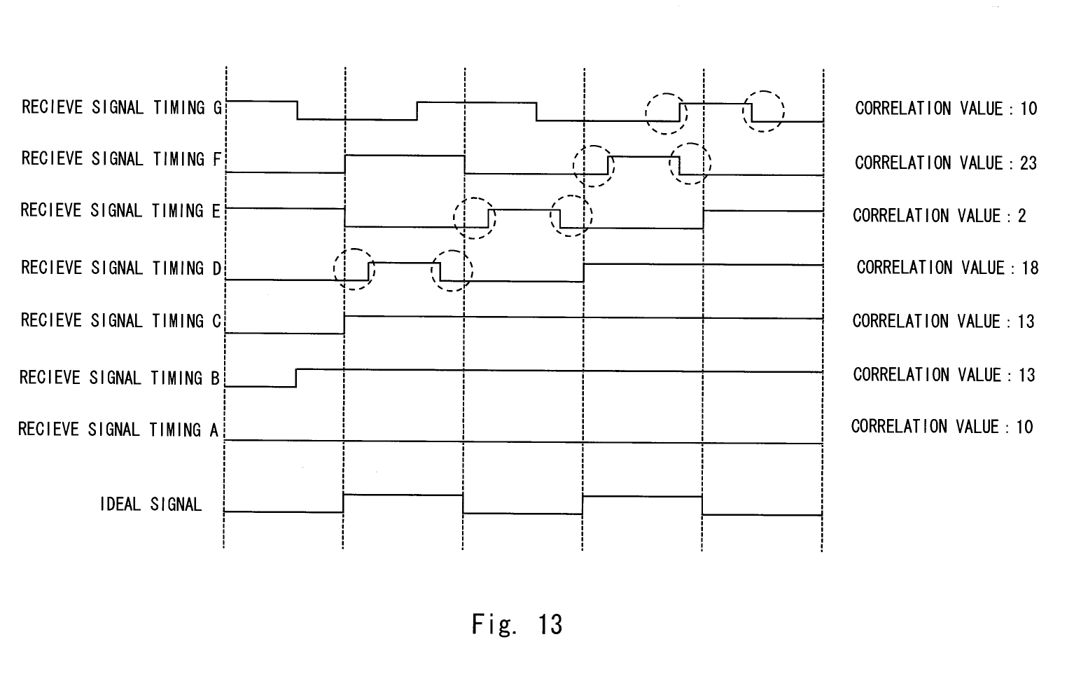

The symbol section estimation unit 53 shown in FIG. 10 estimates a symbol section from the correlation value acquired from the preamble correlation unit 56. A specific estimating method of a symbol section is explained with reference to FIG. 12. Similarly to FIG. 6, FIG. 12 shows correlation values at the time at which respective oversampling is performed, and shows that the correlation value becomes the highest at the timing F. Further, it also shows that the correlation value becomes the lowest at the second sampling from the timing E. Further, it also shows that the correlation value is also maximized at the timing C and the timing D, and the correlation value is minimized at the fifth sampling from the timing C. These timings can be presumed to be a symbol end.

The sampling position specifying unit 54 shown in FIG. 10 specifies the center of the symbol section estimated by the symbol section estimation unit 53 as a sampling position at which sampling is performed to demodulate data in the payload. As seen from the graph of FIG. 12, the estimated symbol end indicates the timing at α, and the timing of the symbol center is thereby presumed to be the timing at α+3 from this estimation.

The demodulation unit 55 shown in FIG. 10 defines the position of the α+3 timing, which is the center of the symbol section specified by the sampling position specifying unit 54, as symbol sampling timing in the payload specified by the synchronization detection unit 52, and performs demodulation.

As has been explained above, the center timing of a symbol section is determined by using a preamble signal series, and then the data can be demodulated by using the center timing. Some of the merits of this exemplary embodiment are described hereinafter. Since the preamble series is expressed as a digital signal “10101010”, adjacent symbols indicate different values. In this way, when a correlation value is calculated in each sample, a plurality of maximum points and minimum points indicating the highest value and lowest value in the correlation value appear. From this, since a symbol section can be estimated by using information on a plurality of places, the estimation of a symbol section can be made more accurately.

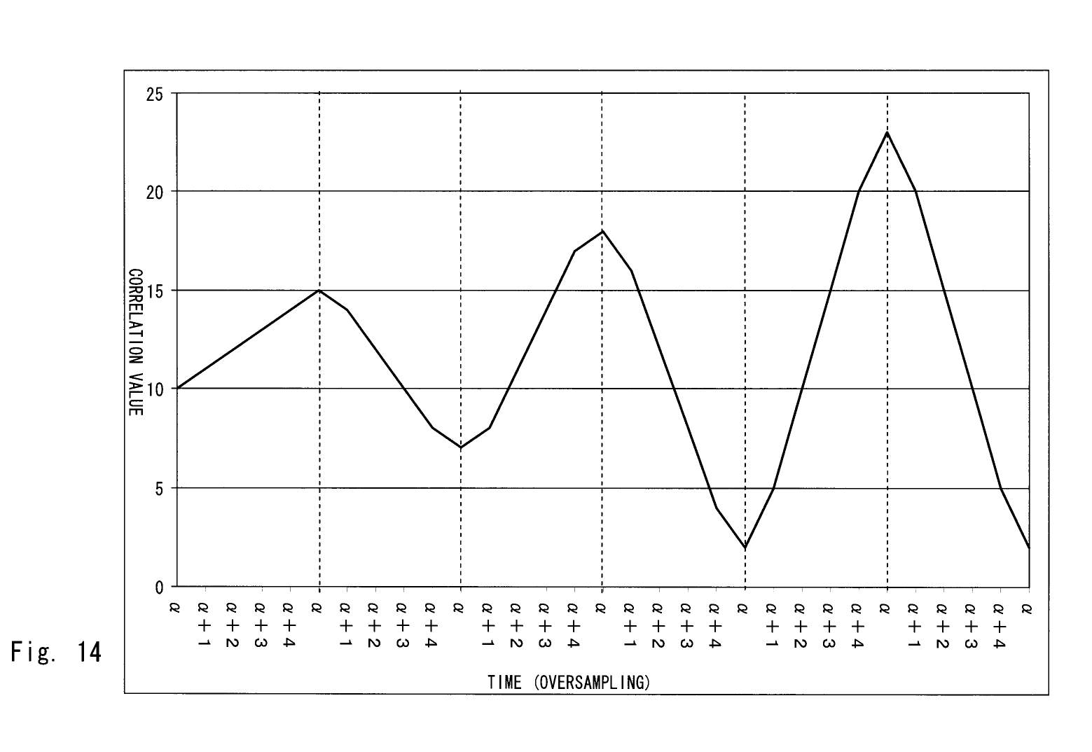

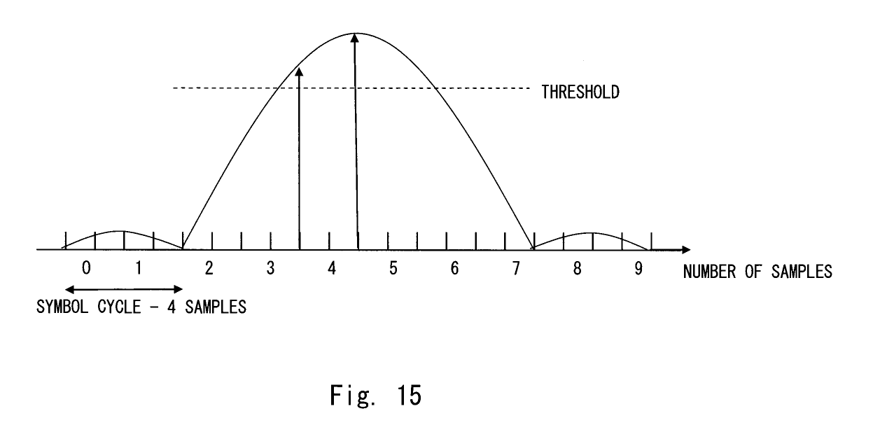

For example, if an error occurs in a signal, the waveform could be changed as shown in FIG. 3. Blocks indicated by dotted lines are portions of the waveform at which an error occurs. As shown in FIG. 14, even when errors occur in a plurality of signals, the sampling timing indicating a symbol end can be presumed to be a from FIG. 14. Since there are a plurality of places at which a symbol section is estimated, a symbol section can be accurately estimated

The above explanation is made only for explaining exemplary embodiments of the present invention, and the present invention is not limited to those exemplary embodiments. Further, various modifications, additions, and conversions can be easily made to any components of the above-described exemplary embodiments by those skilled in the art without departing from the scope of the present invention.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A synchronous processing apparatus comprising:
a correlation unit that obtains correlation between a sample signal and a known signal pattern and acquires a correlation value in succession, the sample signal being generated by oversampling a received analog signal;
a symbol section estimation unit that estimates timing of a symbol section based on the correlation value; and
a sampling position determination unit that determines a sampling position based on timing of a symbol section estimated by the symbol section estimation unit.

2. The synchronous processing apparatus according to claim 1, wherein the symbol section estimation unit detects a sample signal corresponding to a correlation value indicating maximum or minimum among a plurality of correlation values each obtained by the correlation unit for each of the sample signals, and estimate a symbol section based on the detected sample signal.

3. The synchronous processing apparatus according to claim 1, the sampling position determination unit determines center timing of timing of the symbol section estimated by the symbol section estimation unit as a sampling position.

4. The synchronous processing apparatus according to claims 1, wherein
the sample signal includes a predetermined signal pattern, and
the correlation unit obtains a correlation value between the sample signal and the signal pattern.

5. The synchronous processing apparatus according to claims 1, wherein
the sample signal includes a preamble data at a front-end portion of the signal, and
the correlation unit obtains a correlation value between the sample signal and the preamble signal.

6. A receiving apparatus comprising:
a receiving unit that receives an analog signal;
a sample signal generation unit that converts an analog signal received by the receiving unit into a digital signal, and generates a sample signal by performing oversampling;
a correlation unit that obtains correlation between the sample signal and a known signal pattern and acquires a correlation value in succession;
a symbol section estimation unit that estimates timing of a symbol section based on the correlation value; and
a sampling position determination unit that determines a sampling position based on timing of a symbol section estimated by the symbol section estimation unit.

7. A synchronous processing method comprising:
obtaining correlation between a sample signal and a known signal pattern and acquiring a correlation value in succession, the sample signal being generated by oversampling a received analog signal;
estimating timing of a symbol section based on the correlation value; and
determining a sampling position based on timing of the estimated symbol section.

8. The synchronous processing method according to claim 7, further comprising:
detecting a sample signal corresponding to a correlation value indicating maximum or minimum among a plurality of the correlation values each obtained for each of the sample signals, and
estimating a symbol section based on the detected sample signal.

9. The synchronous processing method according to claim 7, further comprising performing sampling at center timing of timing of the estimated symbol section.
